(19) United States
(12) Patent Application Publication
(10) Pub. No.: US 2017/0105362 A1
(43) Pub. Date: Apr. 20, 2017

(54) PLANTING CONTAINER POTTING INSERT

(71) Applicant: Warren Irving, JR., Dublin, OH (US)

(72) Inventor: Warren Irving, JR., Dublin, OH (US)

(21) Appl. No.: 15/266,597

(22) Filed: Sep. 15, 2016

Related U.S. Application Data
(60) Provisional application No. 62/242,376, filed on Oct. 16, 2015.

(51) Int. Cl. A01G 9/10; A01G 1/00; A01G 9/02

(52) U.S. Cl. CPC A01G 9/102; A01G 9/02; A01G 1/001; A01G 9/1086

(57) ABSTRACT

Exemplary embodiments described in the application are directed to planting container potting insert devices and methods of use that simplify the potting of a plant in a planting container having an interior volume that exceeds the volume required by the root material and supporting soil associated with the plant. Exemplary embodiments include a plant receiving and supporting component, and an associated suspension assembly for suspending the plant receiving and supporting component within the interior volume of a planting container of interest. The plant receiving and supporting component may be in the form of a mesh bag.

### CROSS-REFERENCE TO RELATED APPLICATIONS

This application claims the benefit of U.S. Provisional Application No. 62/242,376, filed on Oct. 16, 2015, which is hereby incorporated by reference as if fully recited herein.

### TECHNICAL FIELD

Exemplary inventive embodiments are directed generally to devices designed to facilitate the potting of plants.

### BACKGROUND

A plant residing in a planting container is likely a familiar sight to most people. A variety of plant material is, of course, available from nurseries and other establishments in temporary growing containers, which are designed to be removed at a time when the plant is transferred to a larger container, planted in the ground, etc. Of more interest here, however, is the placement of a plant into a planting container that is intended, in lieu of the ground, to serve as the plant's permanent or perhaps at least, seasonal, home.

While a planting container as mentioned above may certainly be a growing container used by a nursery, etc., more often than not such a planting container will be primarily decorative in nature. Consequently, the selection of a given planting container may or may not take into consideration the size of the plant to be potted.

When the volume of a selected planting container is at least relatively similar to the volume occupied by the root material and soil required to support a plant to be potted therein, the potting process may be quite simple. However, when the volume of a selected planting container is substantially larger than the root material and accompanying soil associated with a plant to be potted therein, the potting process becomes much more complicated because the excess container volume must be filled in order to properly support and secure the plant. This is true whether the planting container is wider, taller, or both wider and taller than necessary. In the case of a planting container having excess height, however, maintaining the proper planting depth of a plant may be particularly challenging.

There are many commonly employed—but poor—techniques for dealing with a planting container that is substantially larger in volume than the portion of a plant that is to be set therein. The most obvious technique is to simply fill the excess volume with soil. Another technique is to fill a portion of the excess volume with other materials such as Styrofoam packing peanuts, rocks, or plastic (e.g., water bottles, milk containers), and to subsequently fill the remainder of the excess volume with soil.

Each of the aforementioned known techniques has significant drawbacks. Using soil to fill the excess volume within a planting container can be expensive, is wasteful, and may also add a significant amount of weight to the container. Like soil, rocks will increase the weight of the container—perhaps to the point of preventing movement thereof in the case of sufficiently large containers. The use of Styrofoam or plastic container filler materials generally eliminates the issue of increased weight but, without adequate forethought and time, such materials are frequently not on hand in sufficient quantities at the time of planting. Likewise, Styrofoam and plastic container filler materials are not environmentally friendly. Furthermore, the irregular shape of Styrofoam and plastic filler materials tends to form an unstable base on which to pot plant material. Both rocks and Styrofoam/plastic filler materials may also interfere with any digging that is required during the potting process, and may act as a barrier to water drainage.

It should be understood from the foregoing remarks that there is a need for a device and method that simplifies the potting of a plant(s) into a planting container having an interior volume that exceeds the volume required by the root material and supporting soil associated with the plant. Exemplary device and method embodiments described herein are such devices and methods.

### SUMMARY

Exemplary planting container potting insert devices and methods of use described herein simplify the potting of a plant(s) in a planting container having an interior volume that exceeds the volume required by the root material and supporting soil associated with the plant. As will become apparent, the benefit of using such exemplary devices and methods increases as the difference between the interior volume of a given planting container and the volume encompassed by the root material and supporting soil associated with a plant(s) to be potted therein increases.

Generally speaking, an exemplary planting container potting insert device embodiment will include a suspendible plant receiving and supporting component and an associated suspension assembly designed to suspend the plant receiving and supporting component within the interior volume of a planting container. The suspendible plant receiving and supporting component may be a mesh bag. The suspension assembly may comprise a plurality of support hooks and related connection elements. During use of an exemplary planting container potting insert, the suspension assembly acts to suspend the plant receiving and supporting component within the interior volume of a given planting container. For example, the support hooks of the suspension assembly may be affixed to the mesh bag and adapted to releasably engage the rim of a planting container within which the planting container potting insert will be installed, such that the mesh bag is suspended within the volume of the planting container.

The mesh bags of exemplary planting container potting inserts are designed and constructed to retain soil but to allow the passage of water. Consequently, the root material of a selected plant may be placed within a suspended mesh bag of an exemplary planting container potting insert along with a sufficient amount of soil, whereby the plant will be securely potted in the planting container to which the planting container potting insert is installed without the need to fill any excess volume of the planting container with one or more filler materials. A plant potted in an exemplary planting container potting insert may be watered, fed and allowed to grow as if planted in the ground or potted in a container completely filled with soil. Alternatively, to removing a plant from the temporary pot in which it is purchased from a greenhouse, etc., before potting, it is also possible to leave the plant in the temporary pot and to place the already potted plant into the mesh bag of an exemplary planting container potting insert.

The suspendible plant receiving and supporting component and suspension assembly of an exemplary planting container potting insert may be dimensioned and otherwise adapted to permit the use of the planting container potting insert with planting containers of many different sizes. Nonetheless, exemplary planting container potting inserts may also be provided in various sizes for use with planting containers within different size ranges.

Other aspects and features of the general inventive concept will become apparent to those skilled in the art upon review of the following detailed description of exemplary embodiments along with the accompanying drawing figures.

### BRIEF DESCRIPTION OF THE DRAWINGS

In the following descriptions of the drawings and exemplary embodiments, like reference numerals across the several views refer to identical or equivalent features, and:

FIG. 1 schematically represents one exemplary embodiment of a planting container potting insert installed within a planting container;

FIG. 2 is an enlarged view of a section of an exemplary planting container potting insert showing elements of a suspension assembly thereof;

FIG. 3 schematically depicts an exemplary embodiment of a planting container potting insert installed within a planting container and having plant material and soil located therein;

FIG. 4 schematically depicts another exemplary embodiment of a planting container potting insert; and

FIGS. 5A-5B schematically depicts still another exemplary embodiment of a planting container potting insert.

### DETAILED DESCRIPTION OF THE EXEMPLARY EMBODIMENTS

The terms “plant”, “plant material” or “planting material” as used herein are intended to include trees, vines, shrubs, herbs, flowers, and other similar living things that commonly grow in the ground, and which may live either temporarily or permanently in a planting container.

“Potting” or “potted” as used herein with respect to a planting container potting insert device is intended to include the placement of a plant into any type of container in which the plant may temporarily or permanently live. Thus, nothing herein is to be interpreted as limiting the described exemplary devices or methods to use with only what might be traditionally considered a plant pot.

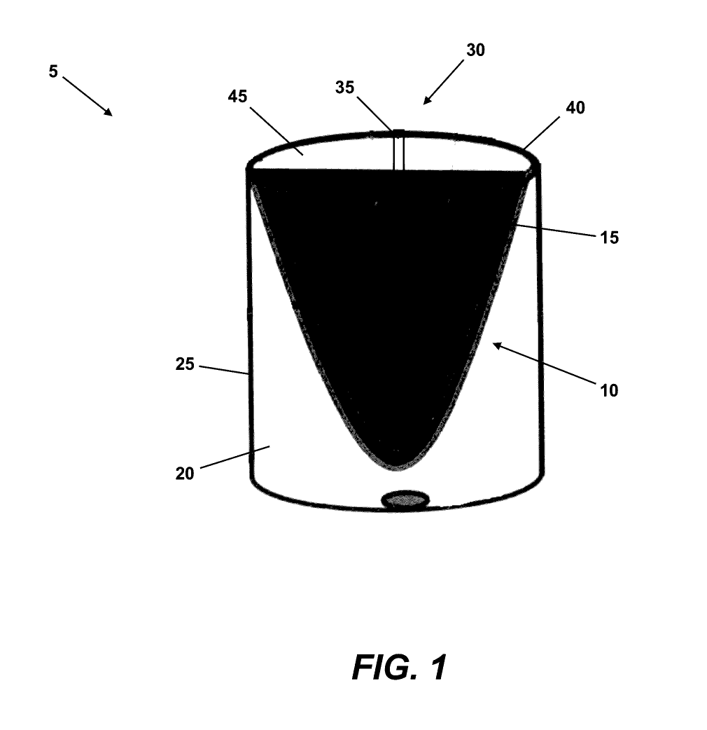

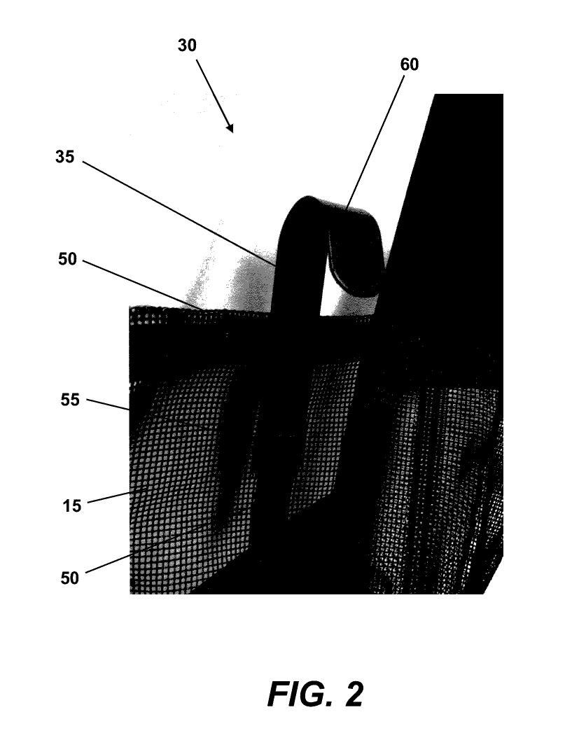

Certain exemplary planting container potting insert device embodiments described herein include a suspendible plant receiving and supporting component and an associated suspension assembly designed to suspend the plant receiving and supporting component within the interior volume of a planting container. One exemplary planting container potting insert device 5 is depicted in FIGS. 1-2.

The planting container potting insert device 5 can be observed in FIG. 1 to include a suspendible plant receiving and supporting component 10, which in this exemplary embodiment, is provided in the form of a water permeable mesh bag 15. The mesh bag 15 may be of various shapes and sizes. The mesh bag 15 may also be constructed of various different materials. In the exemplary embodiment of the planting container potting insert device 5 shown in FIG. 2, the mesh bag 15 is constructed from a polyurethane webbing material that has been cut and stitched together to form a bag.

The mesh bag 15 is shown in FIG. 1 to be suspended within the interior volume 20 of a planting container 25 by a planting container potting insert device suspension assembly 30. More particularly, the suspension assembly is affixed to the mesh bag and is also adapted to releasably engage the rim of the planting container 25 within which the planting container potting insert is installed, such that the mesh bag is suspended within the volume of the planting container.

Referring now also to FIG. 2, it can be better understood that the suspension assembly 30 of this exemplary embodiment comprises a plurality of support hooks 35 each of which has a proximal end affixed to the mesh bag 15 and a distal end that is adapted to engage a rim 40 or other feature of the planting container 25 along the opening 45 therein. In this particular planting container potting insert device 5 embodiment, the support hooks 35 are affixed to the mesh bag 15 using fabric (e.g., nylon) strips 50. The nylon strips 50 are stitched to the mesh bag 15, and are also attached to the support hooks 35 by, for example, passing a nylon strip through an opening 55 provided in each support hook 35. In addition to or in lieu of being stitched to the mesh bag 15 material, the nylon strips 50 may be stitched to themselves.

The support hooks of other planting container potting insert device embodiments may be affixed to the mesh bag 15 in other ways—including by any means known to one of skill in the art. For example, adhesive, a hook and loop fastening system, threaded fastener assemblies, rivets, clamps, and/or other means of hook-to-bag attachment may be employed in other embodiments.

As shown in FIG. 2, the support hooks 35 of this exemplary planting container potting insert device suspension assembly 30 are provided with a pre-bent distal end 60 for engagement with the rim 40 of the planting container 25. In some planting container potting insert device embodiments, the bends placed in the hooks of the suspension assembly may be adjusted to optimize engagement with the rim of a given planting container. In still other embodiments, the hooks may be provided to a user in an unbent state so that the user may bend the distal end of the hooks to the desired shape. In any case, the material from which the hooks are formed should be capable of maintaining the shape of the bent end once an associated planting container potting insert device is placed in a planting container and loaded with plant material, soil, etc.

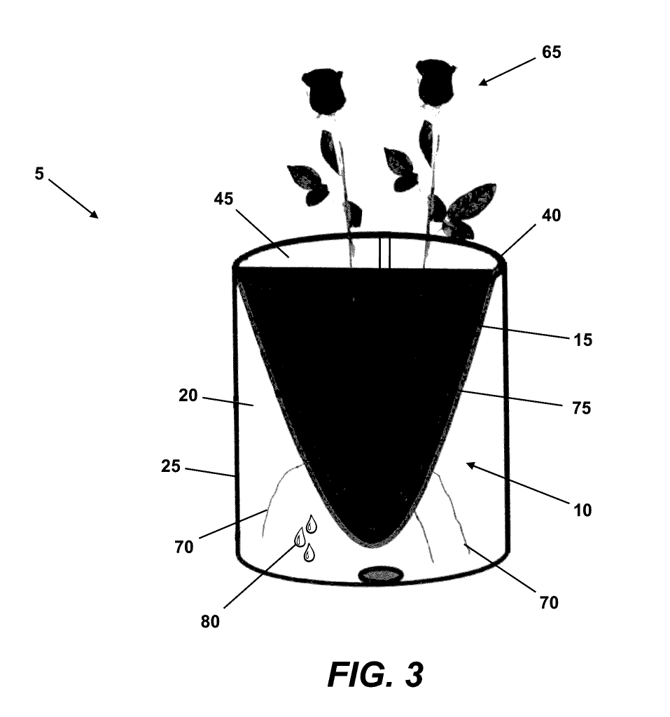

The planting container potting insert device 5 of FIG. 1 is shown in FIG. 3 being used to support planting material 65 in an elevated position within the planting container 25. For purposes of simplicity, the planting material 65 is shown to be flowers in this example. Obviously, additional flowers could be present in this example, and other types and sizes of planting material may be used in other embodiments.

As is apparent from an observation of FIG. 3, the interior volume 20 of this exemplary planting container 25 far exceeds the space required by the roots 70 of the planting material 65 and any necessary accompanying soil 75. Consequently, it should also be apparent that the planting container potting insert device 5 permits potting of the planting material 65 in the planting container 25 at the proper height, without requiring that the entire excess interior volume 20 of the planting container be filled with soil and/or other filler material(s). As discussed above, this simplifies the planting process, reduces material costs, and also minimizes the overall weight of the potted container 25.

As may be further observed in FIG. 3, the nature of the mesh bag 15 may permit the passage of roots 70 as the associated planting material 65 grows. Similarly, excess water 80 may also pass through the mesh bag 15, so that the planting material 65 supported therein does not become waterlogged.

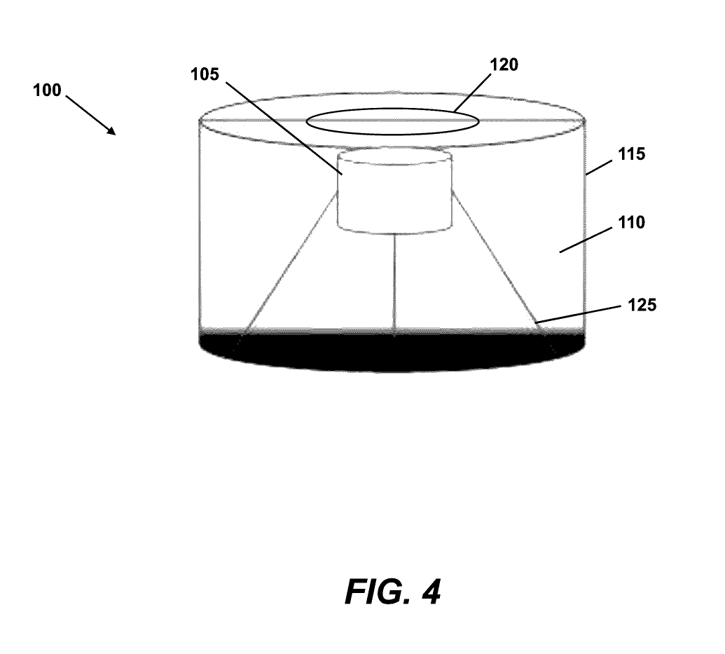

An alternative planting container potting insert device embodiment 100 is schematically represented in FIG. 4. In this exemplary embodiment, the planting container potting insert device 100 includes a planting material receiving and supporting container 105 that has a volume smaller than the interior volume 110 of the planting container 115 into which the planting material is to be potted. The planting material receiving and supporting container 105 may be constructed from various materials and may be perforated or otherwise contain one or more drainage holes to permit the passage of excess water.

The planting material receiving and supporting container 105 is supported at an elevated position within the planting container 115, such as but not necessarily, in a position near the opening 120 of the planting container. A plurality of support legs 125 are employed for maintaining the planting material receiving and supporting container 105 in an elevated position. While three support legs 125 are shown in FIG. 4, other embodiments may employ a greater number of support legs. The support legs 125 may be length-adjustable, whether telescopically or otherwise, to adjust to planting containers of different heights. The support legs 125 may be pivotally connected to the planting material receiving and supporting container 105 to adjust to planting containers of different diameters or widths. Consequently, the position of the planting material receiving and supporting container 105 with respect to the plant container opening 120 may be adjusted.

The planting container potting insert device 100 of FIG. 4 is usable to support planting material in an elevated position within the planting container 115. As with the embodiment of FIG. 3, it can be seen that the interior volume 110 of this exemplary planting container 115 far exceeds the volume provided in which to pot planting material (i.e., the volume provided by the planting material receiving and supporting container 105). Consequently, it should also be apparent that this exemplary planting container potting insert device 100 again permits potting of planting material in a planting container at the proper height, without requiring that the entire excess interior volume of the planting container be filled with soil and/or other filler material(s).

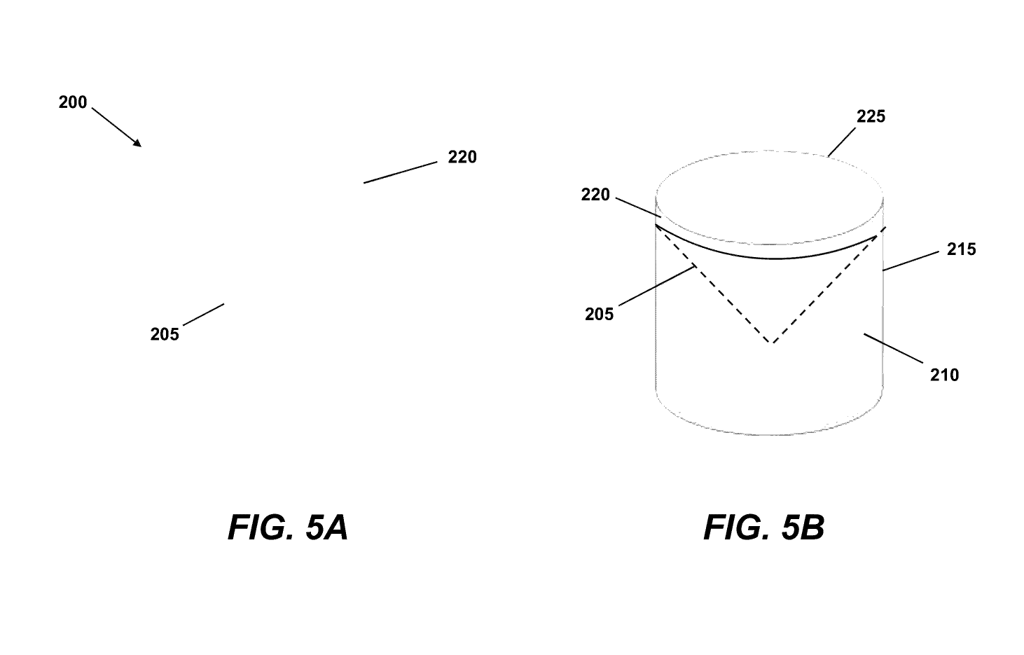

Another alternative planting container potting insert device 200 embodiment is schematically depicted in FIGS. 5A-5B. The exemplary planting container potting insert device 200 again includes a suspendible plant receiving and supporting component in the form of a mesh bag 205, which may have any of the characteristics of the mesh bag 15 described above. The mesh bag 205 is shown in FIGS. 5A-5B to be suspended within the interior volume 210 of a planting container 215 by a planting container potting insert device 220, which is provided in the form of a plastic (e.g., polyurethane) support lining that is adapted to fit over and be retained on the rim 225 of the planting container 215. The suspension device 220 and the mesh bag 205 are is affixed to each other, such that the mesh bag is suspended within the interior volume 210 of the planting container 215.

As with the exemplary embodiment described above and shown in FIG. 3, the planting container potting insert device 200 of FIGS. 5A-5B is usable to suspend planting material in an elevated position within a planting container. Also as with the embodiment of FIG. 3, it can be seen that the interior volume 110 of this exemplary planting container 115 far exceeds the volume of the mesh bag 205. Consequently, it should also be apparent that this exemplary planting container potting insert device 200 again permits potting of planting material in a planting container at the proper height, without requiring that the entire excess interior volume of the planting container be filled with soil and/or other filler material(s).

While certain embodiments of the invention are described in detail above, the scope of the invention is not considered limited by such disclosure, and modifications are possible without departing from the spirit of the invention as evidenced by the following claims:

What is claimed is:

1. A planting container potting insert device, comprising:
a plant receiving and supporting component;
a suspension assembly associated with the plant receiving and supporting component, the suspension assembly including a plurality of support hooks adapted to suspend the plant receiving and supporting component within an interior volume of a planting container of interest by engaging a rim portion of the planting container.

2. The planting container potting insert device of claim 1, wherein the plant receiving and supporting component is a water permeable mesh bag.

3. The planting container potting insert device of claim 2, wherein the mesh bag is constructed from a polyurethane webbing material.

4. The planting container potting insert device of claim 3, wherein the polyurethane webbing material is cut and stitched together to form the mesh bag.

5. The planting container potting insert device of claim 1, wherein the support hooks of the suspension assembly each have a proximal end that is affixed to the plant receiving and supporting component and a distal end that is bent to engage the rim of the planting container.

6. The planting container potting insert device of claim 1, wherein the bent ends of the support hooks are adjustable to optimize engagement with the rim of the planting container.

7. The planting container potting insert device of claim 1, wherein the hooks of the suspension assembly are affixed to the plant receiving and supporting component at least in part using fabric strips that are stitched to the plant receiving and supporting component.

8. The planting container potting insert device of claim 1, wherein the hooks of the suspension assembly are affixed to the plant receiving and supporting component at least in part by passing fabric strips through an opening provided in each support hook.

9. The planting container potting insert device of claim 1, wherein the hooks of the suspension assembly are affixed to the plant receiving and supporting component at least in part using a fastening mechanism selected from the group consisting of adhesive, a hook and loop fastening system, threaded fastener assemblies, rivets, and clamps.

10. A planting container potting insert device, comprising:
a plant receiving and supporting component in the form of a water permeable mesh bag;
a suspension assembly associated with the mesh bag, the suspension assembly including a plurality of support hooks affixed to the mesh bag and adapted to suspend the mesh bag within an interior volume of a planting container of interest by engaging a rim portion of the planting container.

11. The planting container potting insert device of claim 10, wherein the mesh bag is constructed from a polyurethane webbing material that is cut and stitched together.

12. The planting container potting insert device of claim 10, wherein a proximal end of each support hook of the suspension assembly is affixed to the mesh bag and a distal end of each support hook is bent to engage the rim of the planting container.

13. The planting container potting insert device of claim 12, wherein the bent ends of the support hooks are adjustable to optimize engagement with the rim of the planting container.

14. The planting container potting insert device of claim 1, wherein the hooks of the suspension assembly are affixed to the mesh bag at least in part using fabric strips that are stitched to the mesh bag.

15. The planting container potting insert device of claim 1, wherein the hooks of the suspension assembly are affixed to the mesh bag at least in part by passing fabric strips through an opening provided in each support hook.

16. The planting container potting insert device of claim 1, wherein the hooks of the suspension assembly are affixed to the mesh bag at least in part using a fastening mechanism selected from the group consisting of adhesive, a hook and loop fastening system, threaded fastener assemblies, rivets, and clamps.

17. A method of potting a plant in a suspended position within a planting container, comprising:
providing a planting container having a substantially hollow interior volume;
providing a plant receiving and supporting component in the form of a water permeable mesh bag, the volume of the mesh bag being less than the interior volume of the planting container;
associating a suspension assembly with the mesh bag, the suspension assembly including a plurality of support hooks having proximal ends affixed to the mesh bag and distal ends adapted to engage a rim portion of the planting container;
suspending the mesh bag within the interior volume of the planting container using the suspension assembly; and
placing the plant within the mesh bag.

18. The method of claim 17, further comprising placing additional soil within the mesh bag.

19. The method of claim 17, further comprising adjusting the bent ends of the support hooks to optimize engagement thereof with the rim portion of the planting container.

20. The method of claim 20, wherein the mesh bag is constructed from a polyurethane webbing material that is cut and stitched together.
